(19) United States
(12) Patent Application Publication
(10) Pub. No.: US 2011/0289678 A1
(43) Pub. Date: Dec. 1, 2011

(54) Auxiliary Moving Device

(76) Inventor: Miao-Yuan Huang, Xizhi City (TW)

(21) Appl. No.: 12/791,351

(22) Filed: Jun. 1, 2010

(51) Int. Cl. A61G 7/10; A47C 7/02

(52) U.S. Cl. 5/81.1 R; 297/452.48

(57) ABSTRACT

An auxiliary moving device contains two support members; a plurality of connecting sets disposed on two ends of the support members respectively, each end of the support member including one connecting set disposed thereon, and each connecting set including a coupling element with a hole; a number of legs fixed on the connecting sets individually, each leg being connected with one end of the support member by using the connecting set; a plurality of positioning mechanisms fixed on the two ends of the support member respectively, each positioning mechanism including a fixing button to disengage the leg from the hole of the coupling element so that the leg is foldable relative to the support member.

### BACKGROUND OF THE INVENTION

1. Field of the Invention

The present invention relates to an auxiliary moving device, and more particularly to an auxiliary moving device that is foldable.

2. Description of the Prior Art

A disable person has to be cared by a caregiver in daily life to get up, move, eat, have rehabilitation treatment or a bath, etc.

Take a bath for example, the caregiver has to assist the disable person to move toward a bath room, and then make the disable person sit on an auxiliary chair 1 as shown in FIG. 1 to have a bath or other motions. However, legs of the auxiliary chair 1 are fixed that can not be folded, and the auxiliary chair 1 is stored in a larger space, thus occupying store space.

The present invention has arisen to mitigate and/or obviate the afore-described disadvantages.

### SUMMARY OF THE INVENTION

The primary object of the present invention is to provide an auxiliary moving device that is foldable to be stored in a small space.

Another object of the present invention is to provide an auxiliary moving device that a first cushion is provided to hold a second cushion by using a rotating mechanism, and the second cushion rotates relative to the first cushion by ways of the rotating mechanism so that the second cushion is fixed on the first cushion by using a positioning mechanism, such that the disable person sitting on the second cushion allows to rotate on the first cushion by means of the rotating mechanism, and the second cushion is located at the first cushion by using the positioning mechanism, hence the auxiliary moving device having the rotating mechanism and the positioning mechanism can help the disable person rotate or move easily to do some activities in daily life.

To obtain the above objectives, an auxiliary moving device provided by the present invention contains

two support members;

a plurality of connecting sets disposed on two ends of the support members respectively, each end of the support member including one connecting set disposed thereon, and each connecting set including a coupling element with a hole;

a number of legs fixed on the connecting sets individually, each leg being connected with one end of the support member by using the connecting set;

a plurality of positioning mechanisms fixed on the two ends of the support member respectively, each positioning mechanism including a fixing button to disengage the leg from the hole of the coupling element so that the leg is foldable relative to the support member.

Thereby, the coupling element of the connecting set includes a hole, and the positioning mechanism includes a fixing button to disengage form the hole of the coupling element so that the leg is folded relative to the support member, and the fixing button disengages from the hole easily so that the leg of the auxiliary moving device is folded under the support member, thus folding the auxiliary moving device easily and storing the auxiliary moving device in a small space.

### BRIEF DESCRIPTION OF THE DRAWINGS

FIG. 1 is a perspective view of a conventional auxiliary chair;

FIG. 2A is a perspective view showing the operation of an auxiliary moving device according to a first embodiment of the present invention;

FIG. 2B is a perspective view showing the exploded components of the auxiliary moving device according to the first embodiment of the present invention;

FIG. 2C is a plan view showing the auxiliary moving device being folded according to the first embodiment of the present invention;

FIG. 3A shows the positioning mechanism taken along the lines A-A of FIG. 2C.

FIG. 3B is a cross sectional view showing the operation of a positioning mechanism of the auxiliary moving device according to the first embodiment of the present invention;

FIG. 4A is a cross sectional view of a positioning mechanism of an auxiliary moving device according to a second embodiment of the present invention;

FIG. 4B is a cross sectional view showing the operation of the positioning mechanism of the auxiliary moving device according to the second embodiment of the present invention;

FIG. 5A is a cross sectional view of a positioning mechanism of an auxiliary moving device according to a third embodiment of the present invention;

FIG. 5B is a perspective view showing the operation of the positioning mechanism of the auxiliary moving device according to the third embodiment of the present invention;

FIG. 6A is a perspective view showing the operation of an auxiliary moving device according to a fourth embodiment of the present invention;

FIG. 6B is a plan view showing the auxiliary moving device being folded according to the fourth embodiment of the present invention.

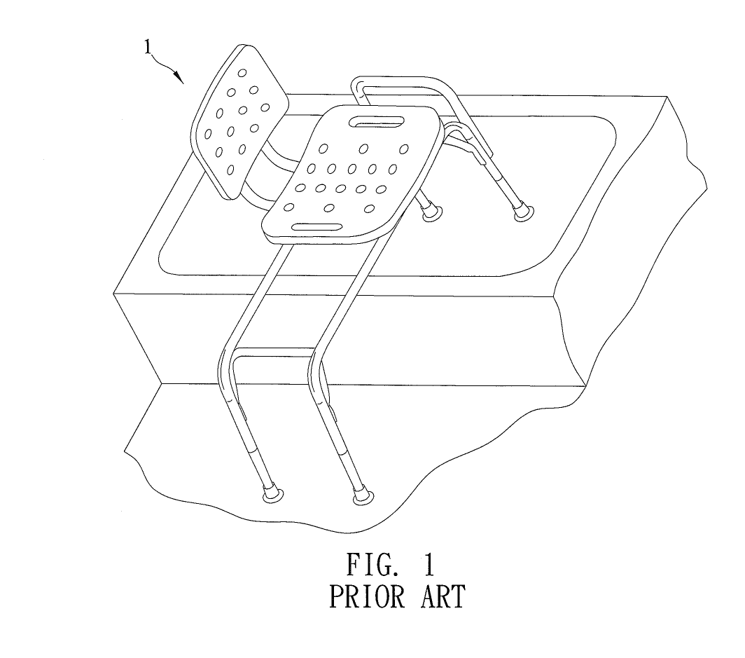

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

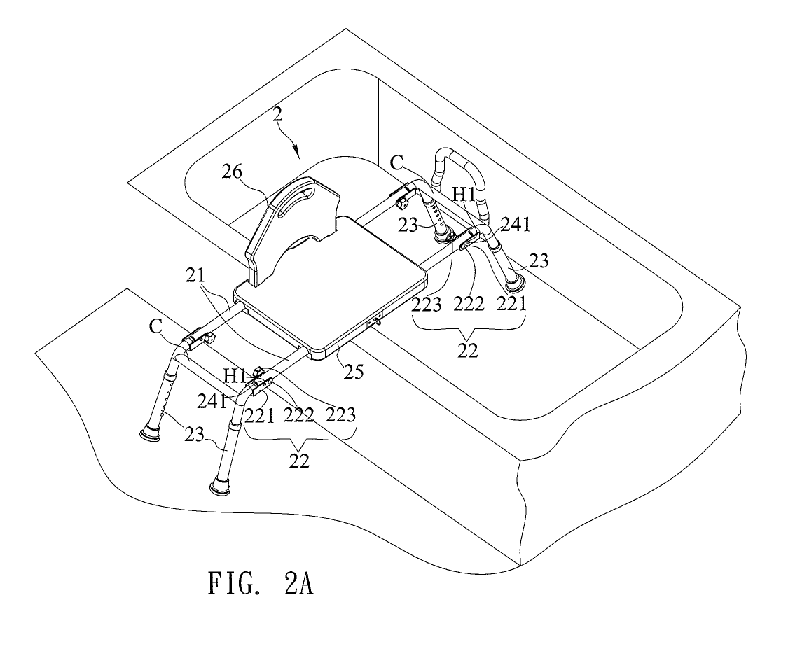

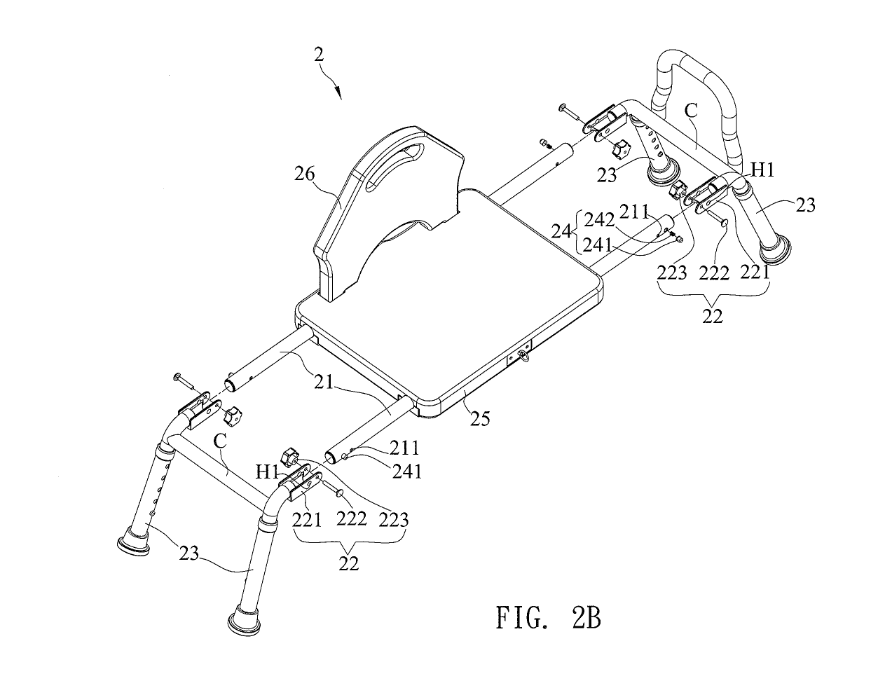

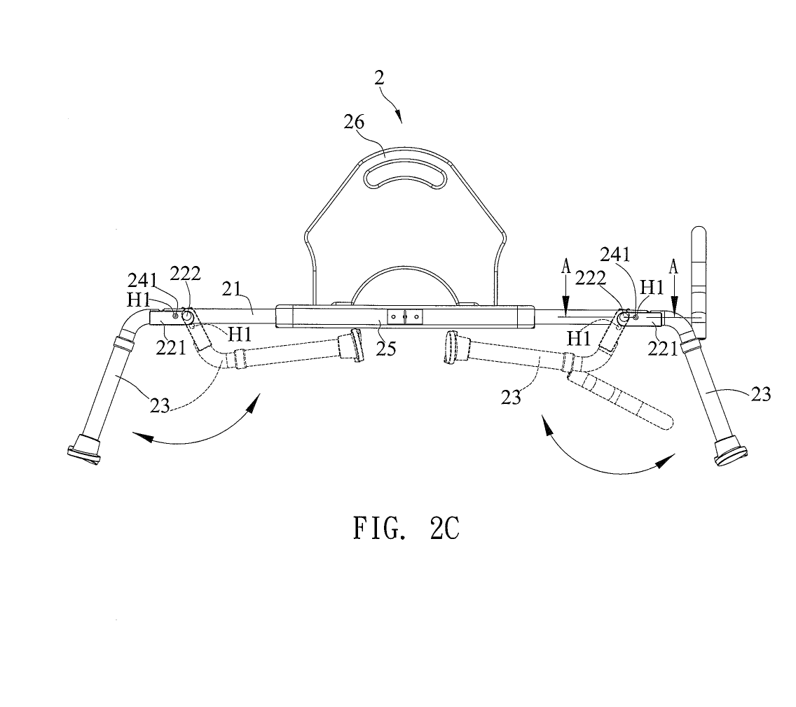

With reference to FIGS. 2A, 2B and 2C, an auxiliary moving device 2 in accordance with a first embodiment of the present invention is not limited to do certain activities, to be used in a certain place, by a specific person, e.g., the auxiliary moving device 2 allows to be used to do activities in any places and by anyone.

The auxiliary moving device 2 includes two support members 21, a plurality of connecting sets 22, legs 23, and positioning mechanisms 24. In this embodiment, the auxiliary moving device 2 includes the two support members 21, four connecting sets 22, legs 23, and positioning mechanisms 24.

The connecting sets 22 are disposed on two ends of the support members 21 respectively, in other words, each end of the support member 21 includes one connecting set 22 disposed thereon, and the connecting set 22 is connected with one end of the support member 21 and includes a coupling element 221 with a hole H1.

The legs 23 are fixed on the connecting sets 22 individually and each leg 23 is connected with the one end of the support member 21. In other words, the connecting set 22 is used to connect the leg 23 and the support member 21 together and further includes a bolt 222 and a rotating element 223 in this embodiment, wherein the bolt 222 is inserted through the coupling element 221 of the connecting set 22 and connected with the rotating element 223.

The leg 23 is inserted through the support member 21 by using the bolt 222 of the connecting set 22 to couple with the support member 21, therefore the support member 21 is inserted through the support member 21 and the coupling element 221 of the connecting set 22 to connect with the leg 23 by ways of the bolt 222 of the connecting set 22, and a shank C is defined between two legs 23 to reinforce the legs 23 securely.

The coupling element 221 of the connecting set 22 is joined with the leg 23 by ways of a connecting method, such as welding, locking, or integral forming. In this embodiment, the coupling element 221 is joined with the leg 23 by welding.

The positioning mechanisms 24 are fixed on the two ends of the support member 21 respectively, e.g., the support member 21 includes two positioning mechanisms 24 mounted on right and left ends thereof individually, wherein the positioning mechanism 24 includes a fixing button 241 to disengage the leg 23 from the hole H1 of the coupling element 221 so that the leg 23 is foldable relative to the support member 21.

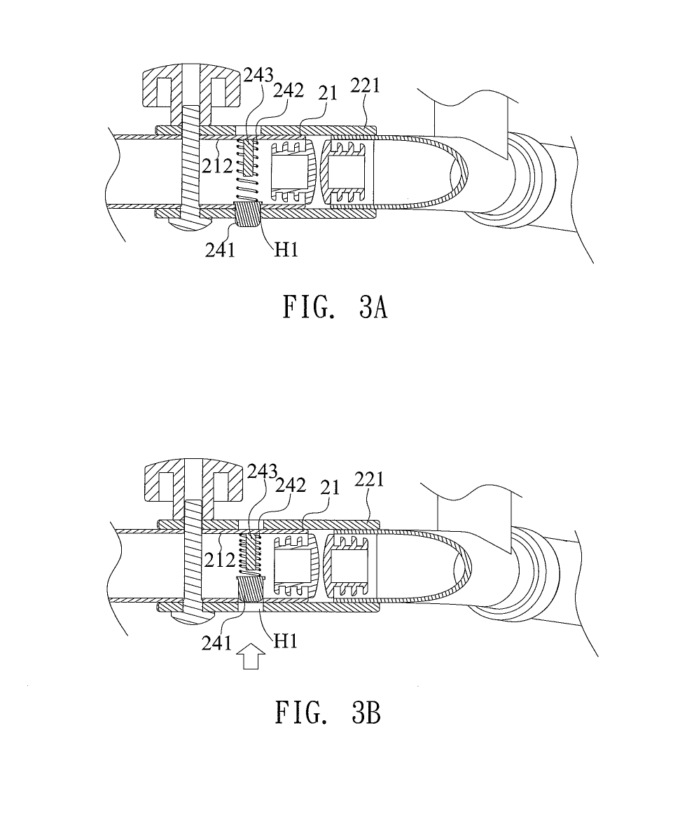

FIG. 3A shows the positioning mechanism taken along the lines A-A of FIG. 2C.

The positioning mechanism 24 also includes a first resilient element 242 and a supporting element 243, both of which are arranged and connected on an inner wall 212 of the support member 21, wherein the first resilient element 242 is fitted in the supporting element 243 and located between the inner wall 212 of the support member 21 and the fixing button 241. In this embodiment, the first resilient element 242 is a spring.

With reference to FIGS. 3A and 3B, in operation of the positioning mechanism 24 (e.g., the leg 23 is not folded in relation to the support member 21), the fixing button 241 of the positioning mechanism 24 is retained in the hole H1 of the coupling element 221 by using the first element 242 so that the leg 23 allows to support the auxiliary moving device 2 by means of the connecting set 22 and the support member 21.

Referring further to FIG. 3B, when the fixing buttons 241 of the positioning mechanisms 24 on the same side of the support members 21 (such as the left side or the right side of the two support members 21) are pressed by a user to disengage from the holes H1 of the connecting sets 22, the fixing buttons 241 press the first resilient elements 242 so that the first resilient elements 242 deform. Meanwhile, the legs 23 as shown in FIG. 2C are rotated by using the bolts 222 of the connecting sets 22 to be folded under the support members 21.

As desiring to use the auxiliary moving device 2 once more, the legs 23 are rotated opposite to a rotating direction as shown in FIG. 2C, and the fixing buttons 241 are pressed to be retained in the holes H1 again, hence the legs 23 are capable of supporting the auxiliary moving device 2.

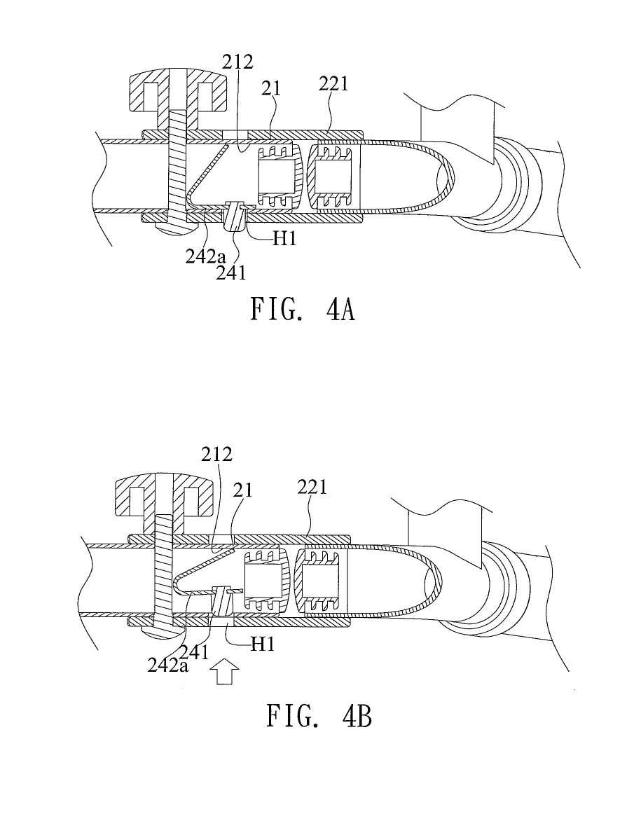

As shown in FIGS. 4A and 4B, a positioning mechanism 24a of the auxiliary moving device 2 according to a second embodiment of the present invention comprises a second resilient element 242a disposed and connected on the inner wall 212 of the support member 21 and inserted into the fixing button 241. In this embodiment, the second resilient element 242a is an elastic piece, wherein the fixing button 241 is coupled with the second resilient element 242a by using welding method, but the fixing button 241 allows to be coupled with the second resilient 242a by using other methods.

Referring to FIG. 4A, in operation, the fixing button 241 of the positioning mechanism 24 is retained in the hole H1 of the connecting set 22 by ways of the second resilient element 242a.

As illustrated in FIG. 4B, when the fixing buttons 241 of the positioning mechanisms 24 on the same side of the support members 21 are pressed to disengage from the holes H1 of the connecting sets 22, the fixing buttons 241 press the second resilient elements 242a so that the second resilient elements 242a deform. In the meantime, the legs 23 are folded under the support members 21 by rotating the bolts 222 of the connecting sets 22.

It is to be noted that any elements to retain the fixing buttons 241 of the positioning mechanism 24 in the holes H1 of the coupling elements 221 allow to be used in this present invention so that the auxiliary moving device 2 is stored, the fixing buttons 241 are pressed to deform the elements, and the legs 23 are folded relative to the support members 21.

With reference to FIG. 2A, the auxiliary moving device 2 further comprises a first cushion 25 and a chair back 26, wherein the first cushion 25 is fixed on the support members 21, and the chair back 26 is secured on the first cushion 25 so that the user sitting on the auxiliary moving device 2 does some activities by using the first cushion 25 and the chair back 26.

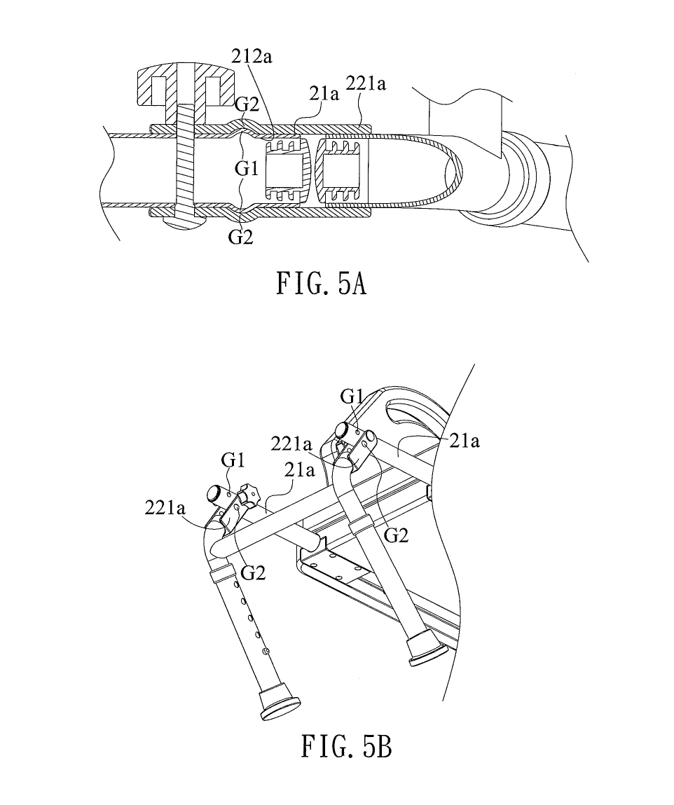

As shown in FIGS. 5A and 5B, a positioning mechanism according to a third embodiment of the present invention comprises two opposite spherical projections G1 formed on an inner wall 212a of a support member 21a, and a coupling element 221a includes two spherically concave portions G2 disposed thereon in response to the spherical projections G1.

In operation, as shown in FIG. 5A, the inner wall 212a of the support member 21a is forced lightly so that the spherical projections G1 are retained in the spherically concave portions G2 of the coupling element 221a.

As shown in FIG. 5B, when the auxiliary moving device 2 is stored, the legs 23 are forced slightly so that the spherical projections G1 disengage from the spherically concave portions G2, hence the legs 23 are rotated to be folded under the support members 21a.

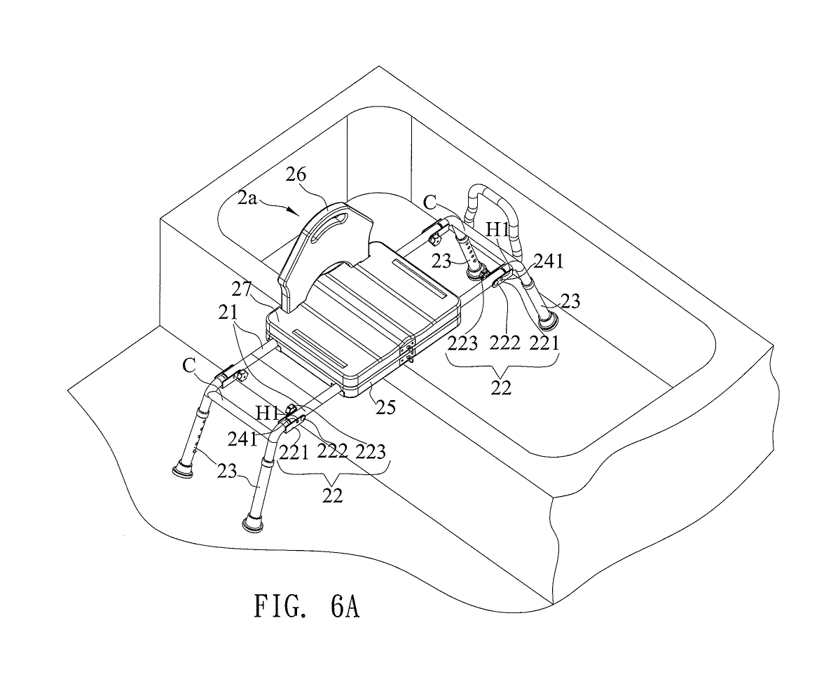

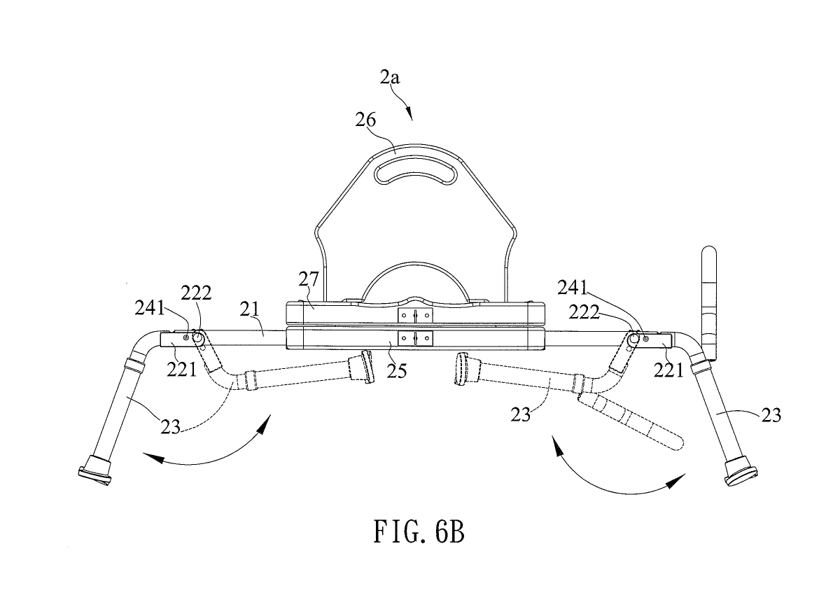

With reference to FIGS. 6A and 6B, an auxiliary moving device 2a in accordance with a fourth embodiment of the present invention further comprises a second cushion 27 defined between the first cushion 25 and the chair back 26. Due to the other related components of the auxiliary moving device 2a are indicial to those of the auxiliary moving device 2, further remarks are omitted.

Thereby, the coupling element of the connecting set includes a hole, and the positioning mechanism includes a fixing button to disengage form the hole of the coupling element so that the leg is folded relative to the support member, and the fixing button disengages from the hole easily so that the leg of the auxiliary moving device is folded under the support member, thus folding the auxiliary moving device easily and storing the auxiliary moving device in a small space.

While we have shown and described various embodiments in accordance with the present invention, it is clear to those skilled in the art that further embodiments may be made without departing from the scope of the present invention.

What is claimed:

1. An auxiliary moving device comprising:
two support members;
a plurality of connecting sets disposed on two ends of the support members respectively, each end of the support member including one connecting set disposed thereon, and each connecting set including a coupling element with a hole;
a number of legs fixed on the connecting sets individually, each leg being connected with one end of the support member by using the connecting set;
a plurality of positioning mechanisms fixed on the two ends of the support member respectively, each positioning mechanism including a fixing button to disengage the leg from the hole of the coupling element so that the leg is foldable relative to the support member.

2. The auxiliary moving device as claimed in claim 1, wherein the coupling element of the connecting set is joined with the leg.

3. The auxiliary moving device as claimed in claim 1, wherein the connecting set includes a bolt and a rotating element, and the bolt is inserted through the coupling element of the connecting set and connected with the rotating element.

4. The auxiliary moving device as claimed in claim 3, wherein the leg is inserted through the hole of the support member by using the bolt of the connecting set to couple with the support member.

5. The auxiliary moving device as claimed in claim 1, wherein the positioning mechanism includes a first resilient element and a supporting element, both of which are arranged and connected on an inner wall of the support member, and the first element is fitted in the supporting element and located between the inner wall of the support member and the fixing button.

6. The auxiliary moving device as claimed in claim 5, wherein when the fixing button of the positioning mechanism disengages from the hole of the connecting set, the fixing button presses the first resilient element so that the first resilient element deforms.

7. The auxiliary moving device as claimed in claim 1, wherein the positioning mechanism includes a second resilient element disposed on the inner wall of the support member and defined between the inner wall of the support member and the fixing button.

8. The auxiliary moving device as claimed in claim 7, wherein when the fixing button of the positioning mechanism disengages from the hole of the connecting set, the fixing button presses the second resilient element so that the second resilient element deforms.

9. The auxiliary moving device as claimed in claim 1 further comprising a first cushion fixed on the support members and a chair back secured on the first cushion.

10. The auxiliary moving device as claimed in claim 9 further comprising a second cushion defined between the first cushion and the chair back.
